(19) United States
(12) Patent Application Publication
(10) Pub. No.: US 2011/0238433 A1
(43) Pub. Date: Sep. 29, 2011

(54) METHOD FOR RAPID AND SECURE INTRODUCTION OF NEW DRUGS, MEDICATIONS AND THERAPIES, THROUGH CLINICAL TRIALS INTO GENERAL HEALTHCARE

(76) Inventor: Fridolin Voegeli, Thalwil (CH)

(21) Appl. No.: 13/036,711

(22) Filed: Feb. 28, 2011

Related U.S. Application Data
(63) Continuation-in-part of application No. 11/720,491, filed on May 17, 2008, now abandoned.

(30) Foreign Application Priority Data
Nov. 30, 2004 (CH) PCT/CH2002/000718

(51) Int. Cl. G06Q 50/00

(52) U.S. Cl. 705/2

(57) ABSTRACT

Accordingly, the object of the invention is one special application of the ‘Health Monitoring Platform’, described in U.S. Pat. No. 6,735,551, with the method of ‘Validated Treatment Plans’, condensing procedure and documentation of the ‘clinical trials’ for a new medication and offering them to the general practitioner on-line: To be used as templates to screen his patient, to select and adapt new treatment for him, to prescribe the associated monitoring to him and to the visiting nurse, to execute a tele-monitoring using sensor devices communicating signals to measurement and event log databases, to assess these logs in consultation with experts, to evaluate deviations from expected outcome and their cause and to propose corrective action and adapted treatment to the caregiver and his patient, searched from this ‘knowledge base’.

### CROSS-REFERENCE TO RELATED APPLICATIONS

This application is a continuation-in-part of U.S. patent application Ser. No. 11/720,491 filed May 17, 2008, which is a 371 of PCT/IB2005/003616 filed Nov. 30, 2005, which claims priority of PCT/CH2002/000718 filed Nov. 30, 2004.

### FIELD OF THE INVENTION

The present invention relates to the combination of an Internet based ‘Condition Monitoring System’ for managing large numbers of patients, monitoring them outpatient at home, as disclosed and patented by the inventor in U.S. Pat. No. 6,735,551, with the method of ‘Validated Treatment Plans’, applying ‘artificial intelligence’ for screening the patients for ‘entry criteria’, for selecting validated ‘treatment prescriptions’, for applying associated ‘compliance and outcome monitoring’, for adapting the treatment based on ‘outcome evidence’ and based on ‘best-treatment’ cases, such system improving efficacy and efficiency of otherwise drawn-out introduction of new drugs into the general practitioners' healthcare.

### BACKGROUND OF THE INVENTION

The healthcare system of most western societies, after only some 50 years of successful operation, is on the verge of collapse:
After 1990 cost of healthcare and time spent to go to see a specialist doctor across the city in his far away office has become increasingly prohibitive. By 2000 many families could no more afford the relationship with their doctor. Medicine has focused on the terminally ills only, has invested into hospitals, clinical diagnostic methods and monitoring technology, invented weird methods like ‘disease management’, all resulting in exorbitant cost.
Homecare programs were started, replacing the missing general practitioner by nurses and paramedics. Impact and success of the programs were expected to be significant, but they failed in spite of high implementation cost and left highly frustrated caregivers and patients, payers and authorities.
Development of a new drug, e.g. to palliate chronic pains, takes 10 to 15 years and the validating ‘clinical phases’ only cost more than 100 million $. But worse, after the approval by the FDA, it takes again years and millions to finally convince, teach and assist the general practitioners to really use the new medication his patients are waiting for on a broad level.
Hardening the markets has grown, because prescribing new drugs, medications and therapies has become risky for the family doctor due to a flood of liability cases, and patients have to accept that the doctor does not want to try these new things anymore, without a back-up by an opinion leader and without the well trained assistance for monitoring ‘compliance’ and ‘outcome’, as he learned and disposed of in his clinical terms.

Design, development and clinical validation of new drugs and new medications has become an enormous undertaking, even for the largest pharmaceutical companies. After years of tests and experiments, in-vitro and in-vivo, the point of no-return is reached when the new agent is going into the ‘clinical trials’, to be tested and validated in humans.

Based on the results of pre-clinical testing, some of the best recognized scientific and medical experts drafted and finalized the frame and detailed guidelines for the trials to be done in the different ‘phases’ of this ‘clinical validation’ of the new drug and its medication. This ‘protocol’ had to be presented to ‘ethical committees’ and had to be accepted by the official authorities, before the first patient could ever be accepted for any clinical testing application.

The tests were structured into 3 consecutive ‘phases’: Phase 1, ‘Tolerability’, to find the ‘maximum tolerated dose’ to be administered to a patient without remaining damage to his health. Phase 2, ‘Indications’, to screen for different diseases and different forms of them that are expected to show a response to the application of the new drug. Phase 3, ‘Medication’, validating different treatments, i.e. type of administration, dosage and intervals; combinations with other drugs; parallel treatment, etc. for specific forms of the diseases found responsive in ‘phase 2’. The end of ‘phase 3’ resulted in a big documentation for all applicable treatments to be approved by Food and Drug Administration (FDA).

At the operational level of the clinical centers performing the different phases, the guidelines for ‘phase 3’ resulted in 3 main documents accompanying each test patient:
(1) a checklist for the ‘Entry Criteria’ in the patient selection examination, containing all the indications and contra-indications admitted;
(2) a template for the ‘Test Procedure’, containing all the prescription for the administration of the drug, for the eating, parallel therapies and activities, etc. and
(3) a template for reporting the ‘Nursing Progress’ or compliance and for documenting the ‘outcome’, containing all the checks to be performed, all the ‘condition measurements’ to be done, with responsibilities, technologies to be used, time schedules, means of reporting, etc., with expected outcome and alarm limits to quit the procedure and call for assistance from the responsible ‘trial monitor’.

Up today most of this data processing and documenting work is still done on paper. Mostly access to the ‘outcome’ in real-time is not possible, even not for the scientific committee.

A whole organizational structure was given to the project with the ‘scientific and medical committee’ as principal, the ‘clinical centers’ with their ‘clinical experts’ as executing body, and a ‘CRO’ (Clinical Research Organization) with its project manager and ‘trial monitors’ for the supervision, data management and data evaluation. Some recent successful clinical validations of new drugs on an average took over 5 years, costing more than 100 million $.

When it comes to introducing the approved drug and its medication to the general practitioners for the application in everyday treatment, outside the infrastructure and resources of the famed university clinic, a new team comes in: Marketing specialists, teaching consultants, product managers, visiting medical sales reps, pharmacists, etc. Their goal is to communicate to the doctor all the benefits of the new medications, to persuade him that he is making a good business while still being secured when administering the new drug and last but not least that his patients will be healthier sooner. This marketing mission is performed with all imaginable means and tools. But still it takes too long before the sales and applications really pick-up; in the sales plans of the pharmaceutical company and in the minds of many chronic patient waiting for relieve.

The first reason being that the general practitioner hesitates to look into new learning and new knowledge gathering. His time of the day is filled with consulting and treating his patients, and he can not afford to invest too much into additional learning that is not supported with the best possible tools and resources. In a recent survey in a practical workshop doctors ranked the calls of medical sales representatives just second to ‘spam’ and confessed that they look for all means to turn down and miss their visits.

Second reason being that the general practitioner got his practical instruction in his clinical terms, where he had his ‘chef’ and expert colleagues supervising his first decisions and treatment instructions, where he had many specialized nurses administering the drugs at the right time to the patient (in ‘clinical phases’ even supervised by the ‘trial monitor’) and where he had another team of assistants doing the ‘outcome’ monitoring (in ‘clinical phases’ again supervised and secured by the ‘trial monitor’). That's the way he learned all about the drugs he will apply for the rest of his professional career.

And now some non-colleagues tell him how to learn fast all about a new treatment, new effects and new side-effects of a new drug, to take new treatment decisions, alone without the ‘chef’ watching over him, defining new treatment instructions to his patient, hoping that the patient will follow them at home, but not having the personnel or infrastructure to check ‘compliance’ and to monitor this new ‘outcome’. No responsible doctor will take these risks and go into new applications at his operational level and in his environment of homecare, which in the end again would result in the old ‘trial and errors approach’.

### SUMMARY OF THE INVENTION

Accordingly, the object of the invention is one special application of the ‘Health Monitoring Platform’, described in U.S. Pat. No. 6,735,551, with the method of ‘Validated Treatment Plans’, condensing procedure and documentation of the ‘clinical trials’ for a new medication and offering them to the general practitioner on-line: To be used as templates to screen his patient, to select and adapt new treatment for him, to prescribe the associated monitoring to him and to the visiting nurse, to execute a tele-monitoring using sensor devices communicating signals to measurement and event log databases, to assess these logs in consultation with experts, to evaluate deviations from expected outcome and their cause and to propose corrective action and adapted treatment to the caregiver and his patient, searched from this ‘knowledge base’.

### BRIEF DESCRIPTION OF THE DRAWINGS

FIG. 1 is a schematic representation of such an Internet platform supporting the different partners in their methods of adapting new medication to the general practitioners office and his attendance area. Centered around the ‘Best-Treatment Knowledge Base’, supported by different data management programs, the distributed users can all view and act on ‘Treatment Prescriptions’ and can all enter monitoring data into ‘Logs’ to be supervised. The patients are monitored through mobile sensors, capturing and transmitting physiological parameters via the Internet.

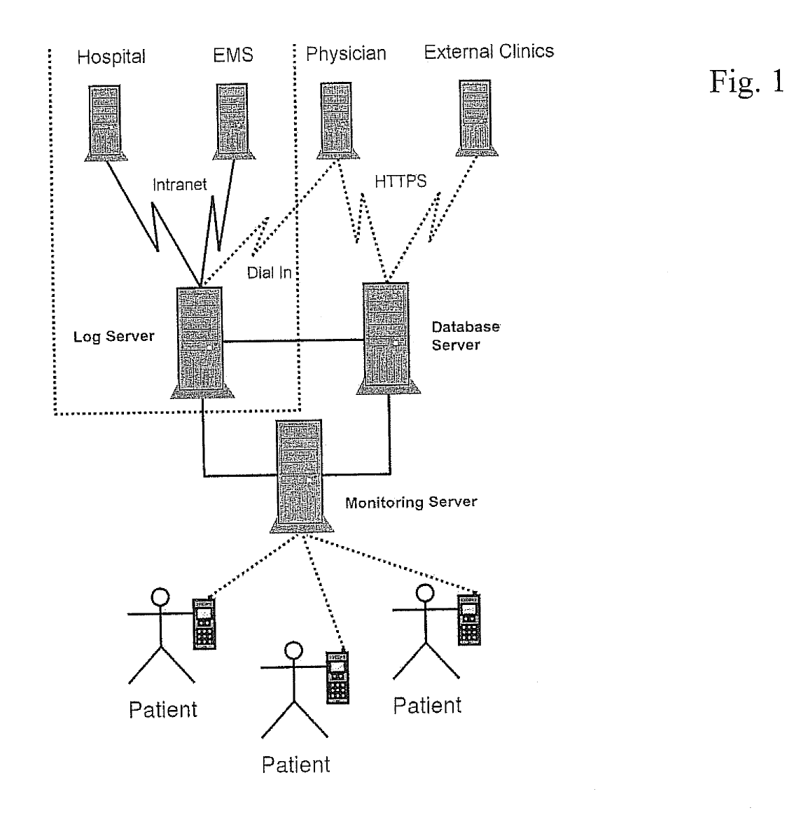

FIG. 2 shows a ‘Validated Treatment Plan’ template, viewed through the standard browser program installed in every PC or PDA. The ‘plan’ has been condensed, edited and included in the ‘Best-Treatment Knowledge Base’ by the experts who designed the ‘clinical trials’. The ‘plan’ contains the 3 main parts, namely ‘Entry Criteria’ checklist, ‘Treatment Prescriptions’ template (opened to show details) and ‘Monitoring Prescriptions’ template.

FIG. 3 depicts in a high level diagram how doctor, patient and caregivers interact on the execution of the ‘Validated Treatment Plan’. The doctor is enabled to change the values in the prescriptions templates and make a ‘Personal Validated Treatment Plan’ out of it. The assisting caregivers can all check the prescriptions they have to follow online and are obliged to feedback the outcome of their actions, to be added to the knowledge base later-on for next optimized treatments. The doctor is enabled to follow-through the whole treatment process, adapt it to the specific ‘outcome’ and make it really ‘validated’ in the field of the care at home.

### DETAILED DESCRIPTION OF THE PREFERRED EMBODIMENTS

The advantages of the invention will become apparent to those engaged in teaching the application of any new therapy and preferably of new drugs upon the following description of the invention with respect to the accompanying drawings, in steps of development and application of the method on the system:

Development of the method for controlling and documenting ‘clinical phase 3’, by ‘clinical experts’:
All the templates for (1) ‘Entry Criteria List’, for (2) ‘Test Procedure’, for (3) ‘Nursing Progress Monitoring’, compiled by the experts and accepted by the ‘scientific and medical committee’, shall be put on the Internet Server database of the system. All experts, specialized doctors, ‘trial monitors’ use these templates to create personal documents for each patient admitted, to reside also on this Internet Server database, accessible for all team members, monitors and supervisors (all the time, where ever they are, only using their standard browser!). These completed forms becoming the documentation of ‘clinical phase 3’, and the ‘best-practice’ knowledge base for the later introduction into general healthcare.

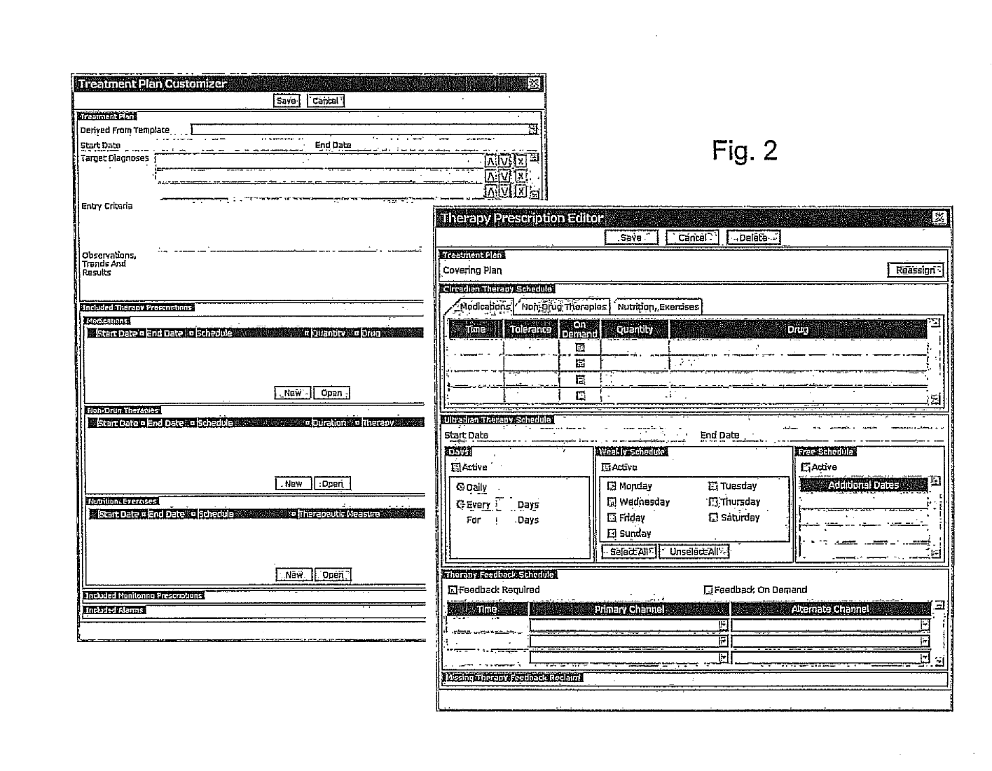

Distribution of the method through ‘knowledge sharing’, by the pharmaceutical companies and ‘clinical experts’:
In addition to the efforts by instructors and sales persons, in conferences, workshops and package instructions, etc., Internet-based ‘Validated Treatment Plans’ (the ‘plans’) are compiled from the completed documents and protocols of ‘clinical phase 3’. (See FIG. 2.) Each ‘plan’ contains the 3 templates (1) ‘Entry Criteria’ checklist, (2) ‘Treatment Prescriptions’ template, (3) ‘Monitoring Prescriptions’ template. The ‘plans’ are integrated into a ‘Best-Treatment Knowledge Base’ in the Internet platform with a powerful search-engine. Then the general practitioner is offered access to the platform, to make immediate use of all the accumulated know-how from all the clinical trials and from all the experts.
The doctor does not have to invest anything into new hardware or software. He just gets access via the standard ‘browser’ in his PC or PDA, in his smart mobile phone, etc.

Applying and selecting the method using ‘Entry Criteria’ check, by the doctor:
The doctor starts his decision making by selecting a ‘Validated Treatment Plan’ and immediately he gets the benefit from the condensed know-how of all the ‘clinical experts’ and from the large number of tests done in the ‘clinical trials’: Going through the ‘Entry Criteria’ checklist of the selected ‘plan’, entering his findings on the patient into the requested fields, the doctor gets his selection of the treatment reconfirmed, or he will be guided to another medication and another ‘plan’, based on the system's search through the ‘Best-Treatment Knowledge Base’.

Personalizing the method using ‘Treatment Prescriptions’ template, by the doctor:
With the selection of the ‘plan’ confirmed in the ‘Entry Criteria’ check, the doctor then adapts the ‘Treatment Prescriptions’ template in the ‘plan’ for his patient's age, weight, sex, contra-indications, etc., by adjusting dosage, timing, eating, parallel therapies, etc. to the specific needs. He prints the ‘Personal Treatment Prescriptions’ for patient and nurse and for the ‘Personal Medical Web-site’ of the patient.

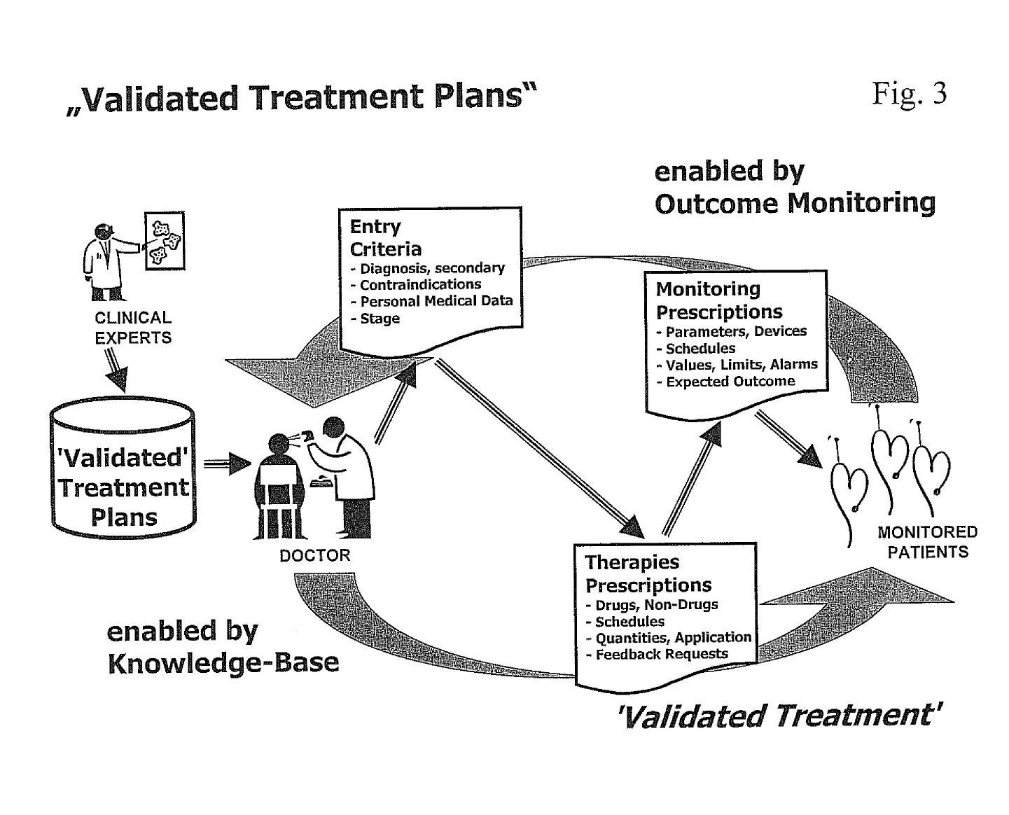

Tailoring the method by adapting a ‘Monitoring Prescriptions’ template, by doctor and nurse:
With the therapies fixed, the doctor then explains to patient and nurse the associated ‘Monitoring Prescriptions’ template that will guide the patient to enter his health condition data. The doctor is enabled to explain the expected ‘outcome’, so all do have complete and transparent confirmation that they are going to comply and to work in the ‘right direction’ on a ‘validated plan’ that worked well in many patients with similar severity of the same problems: They decide, how and with which of the proposed sensors or devices to report ‘compliance’ and ‘outcome’ of the treatment and what values to expect and when. The doctor's assistant hands the device and identification to the patient and starts the monitoring (as in FIG. 3).

Verifying the method, through ‘Outcome Monitoring’, by patient and nurse:
They all had discussed the ‘plan’ with the personalized prescriptions. So now patient and nurse at home can work together following the ‘Treatment Prescriptions’ and ‘Monitoring Prescriptions’: They get reminded if the time for some ‘compliance’ reporting has passed without input, the system captures data automatically, or timed, from the sensors and transmits them on request, or immediately in case of alarm limits passed. The transmission of the data is cross-checked and confirmed. All are assured that the treatment is on-track and all know that in case of any deviation from the expected outcome or any fatal situation they all will be alarmed immediately.

Adaptation of the method, optimizing ‘Treatment Prescriptions’, by the doctor and experts:
The doctor can follow the ‘outcome’, can compare it with the expected results (see FIG. 3) and can discuss the deviations with the patient and the nurse, but also with the experts in the clinical center that had developed and applied the ‘Validated Treatment Plans’, who have been given access to the personalized ‘plan’ of the patient and to the logs and graphs of his condition measurements too. The doctor then can change and adapt the ‘Personal Treatment Prescriptions’ of the patient, based on the evident deviation from expected effects, on discussions with the experts and after searches in the knowledge base.

Enlargement of the ‘Best-Treatment Knowledge Base’, by the experts:
Once the whole ‘Personal Treatment Plan’ has successfully been executed and the expected outcome has been reached, the plan with the 3 parts is added to the new case candidates for the ‘Best-Treatment Knowledge Base’. Periodically these cases are edited and integrated into the knowledge base by the responsible experts and are available to all other doctors searching for ‘best-treatment’ for their patients in their specific diseases and complications.

Once the patient has recovered, he may stay on the platform. His ‘Personal Treatment Plan’ may become a ‘Personal Health Plan’, including hopefully less medications and more physical activity and preventive lifestyle. The ‘Condition Monitoring’ continues, with longer intervals and more focused on performance parameter, the goal being the early detection of any deterioration of basic body functions and the start of best remedy in due time. The next problem is always just around the corner!

Applying such innovative Information Technology and Methods enables researchers, clinical experts, but also general practitioners, for the first time ever to plan their out-clinical treatments, to monitor on-line the ‘outcome’ and to verify on-time corrective actions applied, all in the daily life, natural environment of the patient. A vast field of new knowledge creation has been opened.

1. An Internet-based condition monitoring system for use in treatment of a patient, comprising:
an Internet-based server and communication platform;
a memory associated with the server, said memory storing:
a) a best-treatment knowledge base managing search and access into validated treatment plans based on a number of medical cases,
b) a personalization module, to enable selection and adaptation of an appropriate personal treatment plan for said patient, based on the diagnosis of the patient's diseases and on further assessments of the treatment outcome,
c) a condition monitoring module, adapted to receive and store physiological data measured, alarm signals and event information of the patient,
d) a supervision module, operative to receive and store the alarm signals and event information, assess them and transmit them to doctors, caregivers and experts involved, in order to initiate their reaction and to request a report about the reaction and its results,
e) a shift log for receiving reports related to the patient from such doctors, caregivers and experts,
f) an evaluation module, in which problems and patterns in measurements are evaluated, comparing them with patterns in said knowledge base,
g) a program for selecting appropriate corrective action to be recommended to doctors and caregivers and requesting a report from the caregivers about the reaction and the results, and
h) an editor module, in which reports are entered into the database enlarging the knowledge and the number of cases to select from.

2. A system according to claim 1, whereas the communication platform comprises devices for Internet access, including by PC's, PDA's and Internet accessing smart mobile phones.

3. A system according to claim 1, wherein devices and sensors are provided for measuring the physiological data on the patient and which are connected to the communication platform.

4. A system according to claim 1 comprising a personal medical web-site built into the computer system, with a database containing all personal medical data and personal medical history of each individual patient, and which is accessible by explicit authorization of the individual patient or of his doctor only.

5. A method according to claim 1 comprising a personal treatment plan stored in the computer system, including the doctor's anamnesis and diagnosis within an entry criteria checklist, including the treatment prescriptions with (new) medication, therapies, eating, physical activities, lifestyle for the individual patient, including the measurement prescriptions for monitoring compliance and outcome, defining the parameters to be monitored, with threshold values for alarms, recommending sensors and technology to be applied, scheduling for the monitoring.

6. A method according to claim 1, embedded in the best-treatment knowledge base a validated treatment plan library comprising consolidated and compiled treatment plans from the clinical trials, thus enabling the general practitioner to rapidly apply newly approved drugs and medications into the daily care of his patients at home.

7. Method for implementing new drugs and medications into trials and for applying approved drugs and medications in hospital or home to individual patient wherein an Internet Health Monitoring Platform (as in U.S. Pat. No. 6,735,551) serves as prescription, monitoring and communication system, connecting doctor and individual patient, comprising following steps:
a) Validated Treatment Plan Templates, compiled from completed documentation and protocols of clinical testing phases for said new drugs and medications,
b) a Personalization Module, to enable selection and adaptation of said Validated Treatment Plan Template to a Personal Treatment Plan, based on diagnosis of individual patient's diseases and on further assessments of expected treatment outcome,
c) a Condition Monitoring Module, adapted to receive and store measured physiological data, alarm signals and event information from individual patient,
d) a Supervision Module, operative to receive and store said alarm signals and event information, assess and transmit them to doctors, caregivers and experts involved, in order to initiate their reaction and to request a report about the reaction and its results,
e) an Evaluation Module, in which problems and patterns in measurements are evaluated, comparing them with patterns in a knowledge database,
f) a Recommendation Module, displaying successful corrective action from said knowledge base record to doctors and caregivers and requesting a report from the caregivers about the reaction and the results, and
g) an Editor Module, in which said reports are entered into the database, continually enlarging knowledge and number of cases to select from.

8. Method according to claim 7, wherein the Personal Treatment Plan is stored on the platform including the doctor's anamnesis and diagnosis within an Entry Criteria Checklist, including Treatment Prescriptions, comprising medication, therapies, eating, physical activities, and lifestyle for the individual patient, further including Measurement Prescriptions for monitoring compliance and outcome, defining parameters to be monitored, with threshold values for alarms, recommending sensors and technology to be applied, and scheduling for the monitoring.

9. Method according to claim 7, comprising in the Best-Treatment Knowledge Base consolidated and compiled Treatment Plan Templates from the clinical trials tests, thus enabling the general practitioner to rapidly apply this newly approved drugs and medications into the daily care of his patients at home, embedded in the securing framework of the Validated Treatment Plan Templates.
